(19) United States
(12) Patent Application Publication
(10) Pub. No.: US 2026/0291688 A1
(43) Pub. Date: Sep. 24, 2026

(54) DATA TRANSFER METHOD AND WIRELESS COMMUNICATION DEVICE

(71) Applicant: SHENZHEN TCL NEW TECHNOLOGY CO., LTD., Shenzhen, Guangdong (CN)

(72) Inventors: Yincheng ZHANG, Shenzhen, Guangdong (CN); Miao QU, Shenzhen, Guangdong (CN)

(73) Assignee: SHENZHEN TCL NEW TECHNOLOGY CO., LTD., Shenzhen, Guangdong (CN)

(21) Appl. No.: 19/473,149

(22) PCT Filed: Apr. 7, 2023
(86) PCT No.: PCT/CN2023/086985

§ 371 Date: Oct. 7, 2025

(51) Int. Cl. H04L 5/00; H04L 1/00; H04W 72/21

(52) U.S. Cl. CPC H04L 5/0053; H04L 1/0003; H04L 1/0009; H04W 72/21

(57) ABSTRACT

The disclosure provides a data transfer method. The data transfer method may be executed by a wireless communication device. The wireless communication device may be a base station or a user equipment (UE). The wireless communication device transmits or receives data by an enhanced radio bearer (RB) between a user equipment and a base station, wherein enhanced radio bearer comprises an indication for the data.

### TECHNICAL FIELD

The present disclosure relates to the field of communication systems, and more particularly, to a data transfer method and a wireless communication device.

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN comprises a set of base stations (BSs) that provide wireless links to the UEs located in cells covered by the base station, and an interface to a core network (CN) which provides overall network control. As is to be appreciated the RAN and CN each conduct respective functions in relation to the overall network. The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a gNB.

### Technical Problem

In developing artificial intelligence (AI)/machine learning (ML) over air interface, 3GPP has achieve the conclusion:
Data collection may be performed for different purposes in LCM, e.g., model training, model inference, model monitoring, model selection, model update, etc. each may be done with different requirements and potential specification impact.

Current control plane (CP) and user plane (UP) protocols does not support AI data collection for different radio protocol layers.

It is not clear how to support AI data collection based on user plane protocol.

### Technical Solution

An object of the present disclosure is to propose a wireless communication device, such as a user equipment (UE) or a base station, and a data transfer method for data collection and data management.

In a first aspect, an embodiment of the invention provides data transfer method, executable in a wireless communication device, comprising:
transferring data between a user equipment (UE) and a base station by an enhanced radio bearer (RB) or a control information unit of the radio protocol layer, wherein the data transfer is between a function entity in the UE and a function entity in the base station.

In a second aspect, an embodiment of the invention provides a wireless communication device comprising a processor configured to call and run a computer program stored in a memory, to cause a device in which the processor is installed to execute the disclosed method.

The disclosed method may be implemented in a chip. The chip may include a processor, configured to call and run a computer program stored in a memory, to cause a device in which the chip is installed to execute the disclosed method.

The disclosed method may be programmed as computer-executable instructions stored in non-transitory computer-readable medium. The non-transitory computer-readable medium, when loaded to a computer, directs a processor of the computer to execute the disclosed method.

The non-transitory computer-readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

The disclosed method may be programmed as a computer program product, which causes a computer to execute the disclosed method.

The disclosed method may be programmed as a computer program, which causes a computer to execute the disclosed method.

### Advantageous Effects

The data delivery/transfer for data collection also includes two directions, i.e., a downlink direction from a network (NW) to UE or an uplink direction from UE to NW, and the data delivery/transfers is between a function entity in the UE and a function entity in the gNB.

Embodiments of the disclosure provides solutions for data collection and transfer using control messages or an enhanced radio bearer in a radio access network. The control message in Uu interface is enhanced to transmits data or data segments. Indexing information for data segmentation and concatenation for reproducing the collected data is also include in the control message. The control message may be transmitted in two-stage control messages, including a first-stage control message and a second-stage control message. The first-stage control message comprises overall information of the collected data, an introduction and an index to the second-stage control message. The second-stage control message comprises more details of the collected data. A Data collection function entity may be located in one or more of radio resource control (RRC) layer, Packet Data Convergence Protocol (PDCP) layer, medium access control (MAC) layer, and physical (PHY) layer. Alternatively, the Data collection function entity may be a standalone module commonly shared and interacting with the layers. The data collection function may be activated or deactivated by a control signal, such as downlink control information (DCI), a MAC CE, or an RRC message.

The enhanced radio bearer may be an SRB or a DRB. QoS parameters and configuration for different layers are configured for the enhanced radio bearer. The enhanced radio bearer may be established based on a EstablishmentCause that indicates an establishment cause for transmission of the collected data.

The collected AI data may be used as training data for the model training and inference data for the model inference.

The disclosure provides a mechanism for data collection and transfer using control plane signals, thus facilitating machine learning or AI to be applied to assist control plane functions, such as decision for beam operations, cell selection, operating state transition, and others.

### DESCRIPTION OF DRAWINGS

In order to more clearly illustrate the embodiments of the present disclosure or related art, the following figures is to be described in the embodiments are briefly introduced. It is obvious that the drawings are merely some embodiments of the present disclosure. A person having ordinary skill in this field can obtain other figures according to these figures without paying the premise.

FIG. 1 illustrates a schematic view showing control plane protocol stacks.

FIG. 2 illustrates a schematic view showing user plane protocol stacks.

FIG. 3 illustrates a schematic view showing protocol stacks in a network.

FIG. 4 illustrates a schematic view showing an example wireless communication system comprising a user equipment (UE), a base station, and a network entity.

FIG. 5 illustrates a schematic view showing a system with machine learning capability.

FIG. 6 illustrates a schematic view showing an embodiment of the disclosed method.

FIG. 7 illustrates a schematic view showing control plane and user plane protocol stacks.

FIG. 8 illustrates a schematic view showing an example of commonly shared data collection functions.

FIG. 9 illustrates a schematic view showing an example of distributed data collection functions.

FIG. 10 illustrates a schematic view showing another example of distributed data collection functions.

FIG. 12 illustrates a schematic view showing a data structure of a new UCI format, which includes an indication of an order of AI data segmentation and AI data.

FIG. 12 illustrates a schematic view showing a UCI format supporting cross-slot transmission.

FIG. 13 illustrates a schematic view showing a MAC CE.

FIG. 14 illustrates a schematic view showing a MAC CE with a serving cell ID.

FIG. 15 illustrates a schematic view showing a MAC CE with a serving cell ID supporting segmentation and concatenation.

FIG. 16 illustrates a schematic view showing a MAC CE supporting segmentation and concatenation.

FIG. 17 illustrates a schematic view showing a RLC control PDU for AI data collection.

FIG. 18 illustrates a schematic view showing a RLC control PDU for AI data collection supporting segmentation and concatenation.

FIG. 19 illustrates a schematic view showing a PDCP Control PDU for AI data collection.

FIG. 20 illustrates a schematic view showing a PDCP Control PDU for AI data collection supporting segmentation and concatenation.

FIG. 21 illustrates a schematic view showing a system where a Data collection function entity is located in a RRC entity.

FIG. 22 illustrates a schematic view showing a system where a Data collection function entity is located out of a RRC entity.

FIG. 23 illustrates a schematic view showing a system for wireless communication according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

An objective of the disclosure is to enhance the capability of data transmission between UE and RAN over radio access network, especially a radio network system defined in 3GPP, such as a UMTS Terrestrial Radio Access Network (UTRAN), Evolved UMTS Terrestrial Radio Access Network (E-UTRAN) and New Radio (NR) radio communication system.

Abbreviations used in the description are listed in the following:

TABLE 1

| | |
|---|---|
| 3G | Third generation |
| 3GPP | Third Generation Partnership Project |
| 5GC | 5G Core Network |
| 5GS | 5G System |
| AMF | Access and Mobility Management Function |
| BS | Base station |
| CE | Control element |
| CGI | Cell global identity |
| CN | Core network |
| CPT | Control PDU type |
| C-RNTI | Cell-Radio Network Temporary Identity |
| CQI | Channel quality indicator(CQI) |
| CSI | Channel state information (CSI) |
| DCI | downlink control information (DCI) |
| DL | Downlink |
| DRB | Data radio bearer |
| eLCID | Extended Logical Channel ID |
| eMMB | enhance Mobile Broadband |
| E-UTRAN | Evolved UMTS Territorial Radio Access Network |
| gNB | Generation Node B |
| HARQ | Hybrid automatic repeat request (HARQ) |
| HARQ-ACK | HARQ acknowledgement/negative-acknowledgement |
| | feedback |
| ID | Identifier/Identification |
| IP | Internet Protocol |
| LCID | Logical channel ID (LCID) |
| LTE | Long Term Evolution |
| MAC | Media Access Control |
| NR | New Radio |
| NW | Network |
| OFDM | Orthogonal frequency division multiplexing (OFDM) |
| PDU | Protocol data unit (PDU) |
| PMI | Precoding Matrix Indicator (PMI) |
| PUCCH | Physical uplink control channel (PUCCH) |
| QoS | Quality of Service |
| RAN | Radio Access Network |
| RB | Resource block/Radio block |
| RLC | Radio Link Control |
| SDAP | Service Data Adaptation Protocol |
| SDU | Service Data Unit |
| SMF | Session management function |
| SN | Sequence number |
| SR | Scheduling request (SR) |
| SRB | Signal radio bearer |
| UCI | Uplink control information |
| UDP | User datagram protocol |
| UE | User Equipment |
| URLLC | Ultra-Reliable and Low Latency Communication |
| UPF | User Plane Function |
| UL | Uplink |

In the description, packets, protocol data unit (PDU), and/or PDU sets of a service are referred to as traffic or traffic flow for simplicity.

In the description, a packet may be a PDU or a SDU of a protocol layer. For simplicity, the term packet may refer to a PDU or SDU, and the term PDU may refer to a PDU or SDU.

Embodiments of the disclosure are related to artificial intelligence (AI) and machine learning (ML) for new radio (NR) air interface and address problems of AI data collection and transmission.

For simplicity, an AI/ML model, AI model, ML model, and model are interchangeably used in the description. In the description, device operations may comprise channel state information (CSI) reporting, beam prediction, positioning, and others. Model operations may comprise model selection, activation, deactivation, switching, fallback, model training, model monitoring, and/or fine-tuning at least for one-sided models and two-sided models.

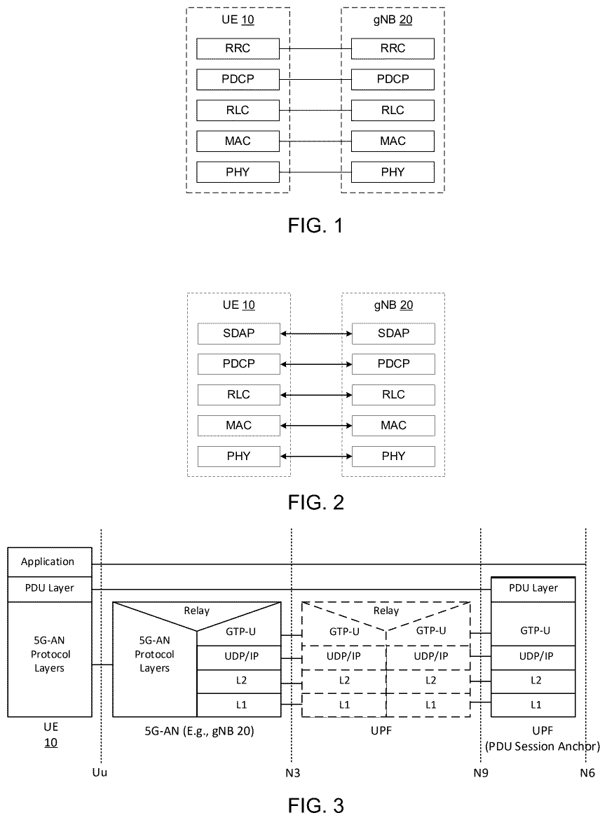

According to current 3GPP specification, the radio protocol stack of Uu interface between UE and gNB consists of control plane (CP) protocol stacks and user plane (UP) protocol stacks which are shown FIG. 1 and FIG. 2 respectively.

A CP-based methods for AI data transmission in the existing frameworks means the data are delivered and transferred using RRC messages.

The user plane protocol stack in the Uu interface (also name 5G AN Protocol Layer in FIG. 3) is part of the whole user plane protocol stack in 5GS which consists of Uu, N3 and N9 interfaces.

The user plane is used to carry PDU between UE and UPF for service data between UE and DN. The PDU type depends on the PDU session type. For example, the PDU corresponds to IPv4 packets or IPv6 packets or both of them when the PDU Session Type is IPv4 or IPv6 or IPv4v6; the PDU corresponds to Ethernet frames when the PDU Session Type is Ethernet.

Based on radio protocol stack, radio bearer (RB) is defined and consists of a series of configured resources for data transmission, such as PHY, MAC, RLC and/or PDCP protocol layer. Radio bearers are categorized into two groups: data radio bearers (DRB) for user plane data and signalling radio bearers (SRB) for control plane data. That is, DRB is for user plane, and SRB is for control plane.

On the other hand, AI data collection can happen in different layers and different nodes. Especially in the 5G RAN (also called NG RAN) which consists of UE and gNB, the data collection can happen in any protocol layer, such as PHY, MAC, RLC, PDCP, and/or SDAP, in UE and/or gNB.

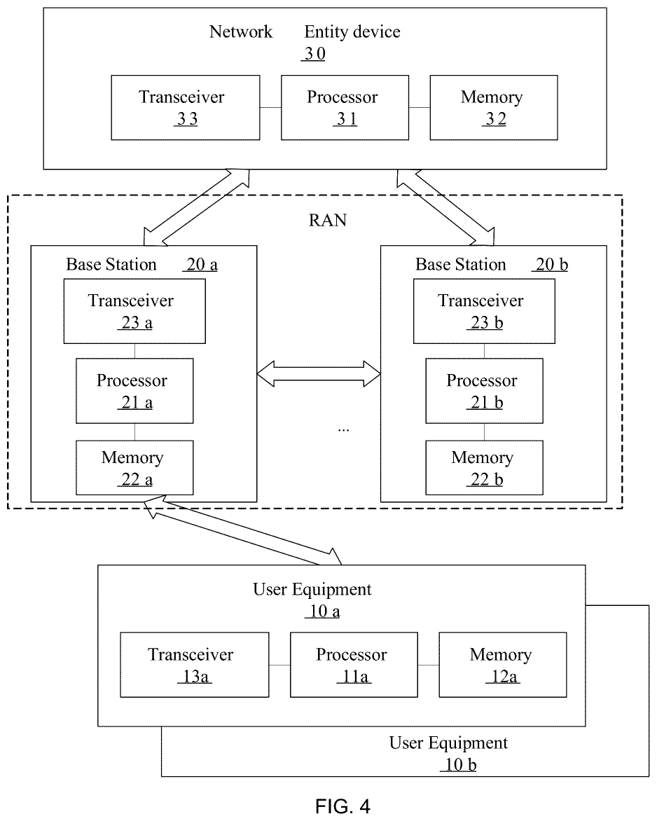

With reference to FIG. 4, a telecommunication system including a UE 10a, a base station 20a, a base station 20b, and a network entity device 30 executes the disclosed method according to an embodiment of the present disclosure. FIG. 4 is shown for illustrative, not limiting, and the system may comprise more UEs, BSs, and CN entities. Connections between devices and device components are shown as lines and arrows in the FIGs. The UE 10a may include a processor Ila, a memory 12a, and a transceiver 13a. The base station 20a may include a processor 21a, a memory 22a, and a transceiver 23a. The base station 20b may include a processor 21b, a memory 22b, and a transceiver 23b. The network entity device 30 may include a processor 31, a memory 32, and a transceiver 33. Each of the processors Ila, 21a, 21b, and 31 may be configured to implement the proposed functions, procedures, and/or methods described in this description. Layers of radio interface protocol may be implemented in the processors 11a, 21a, 21b, and 31. Each of the memory 12a, 22a, 22b, and 32 operatively stores a variety of programs and information to operate a connected processor. Each of the transceivers 13a, 23a, 23b, and 33 is operatively coupled with a connected processor, and transmits and/or receives a radio signal. Each of the base stations 20a and 20b may be an eNB, a gNB, or one of other radio nodes.

Each of the processors 11a, 21a, 21b, and 31 may include a general-purpose central processing unit (CPU), application-specific integrated circuits (ASICs), other chipsets, logic circuits and/or data processing devices. Each of the memory 12a, 22a, 22b, and 32 may include read-only memory (ROM), a random-access memory (RAM), a flash memory, a memory card, a storage medium and/or other storage devices. Each of the transceivers 13a, 23a, 23b, and 33 may include baseband circuitry and radio frequency (RE) circuitry to process radio frequency signals. When the embodiments are implemented in software, the techniques described herein can be implemented with modules, procedures, functions, entities and so on, that perform the functions described herein. The modules can be stored in a memory and executed by the processors. The memory can be implemented within a processor or external to the processor, in which those can be communicatively coupled to the processor via various means are known in the art.

The network entity device 30 may be a node in a CN. CN may include LTE CN or 5GC which may include user plane function (UPF), session management function (SMF), mobility management function (AMF), unified data management (UDM), policy control function (PCF), control plane (CP)/user plane (UP) separation (CUPS), authentication server (AUSF), network slice selection function (NSSF), and the network exposure function (NEF).

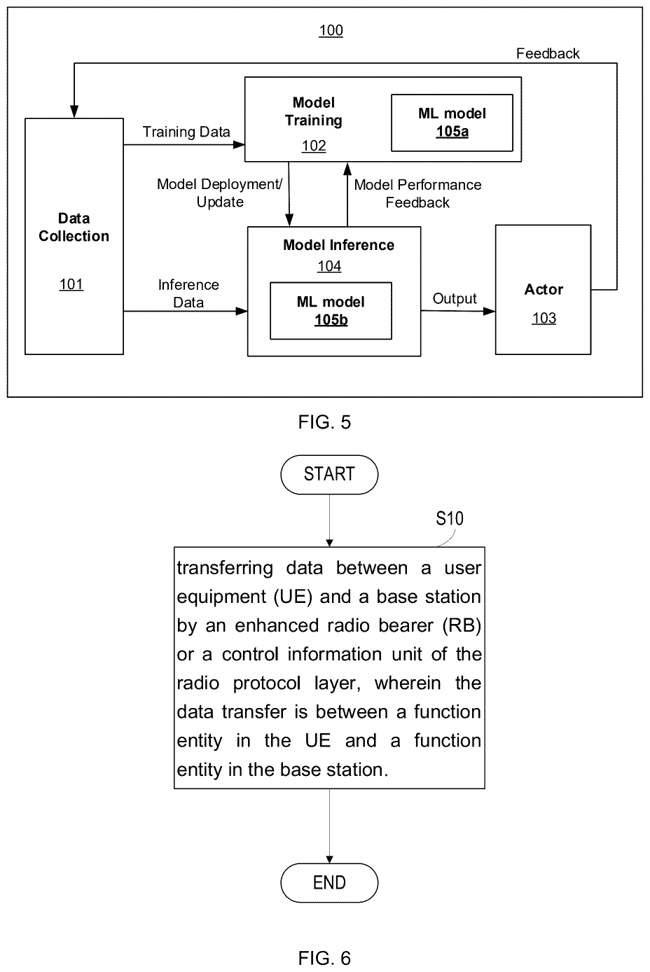

With reference to FIG. 5, a system 100 for the data transfer method for machine learning comprises units of data collection 101, model training unit 102, actor 103, and model inference 104. Please note that FIG. 5 does not necessarily limit the data collection method to the instant example. The data transfer method is applicable to any design based on machine learning. The general steps comprise data collection and/or model training and/or model inference and/or (an) actor(s).

The data collection unit 101 is a function that provides input data to the model training unit 102 and the model inference unit 104. AI/ML algorithm-specific data preparation (e.g., data pre-processing and cleaning, formatting, and transformation) is not carried out in the data collection unit 101.

Examples of input data may include measurements from UEs or different network entities, feedback from Actor 103, and output from an AI/ML model.

Training data is data needed as input for the AI/ML Model training unit 102.

Inference data is data needed as input for the AI/ML Model inference unit 104.

The model training unit 102 is a function that performs the ML model training, validation, and testing. The Model training unit 102 is also responsible for data preparation (e.g., data pre-processing and cleaning, formatting, and transformation) based on training data delivered by the data collection unit 101, if required.

Model Deployment/Update between units 102 and 104 involves deployment or update of an AI/ML model (e.g., a trained machine learning model 105a or 105b) to the model inference unit 104. The model training unit 102 uses data units as training data to train a machine learning model 105a and generates a trained machine learning model 105b from the machine learning model 105a.

The model inference unit 104 is a function that provides AI/ML model inference output (e.g., predictions or decisions). The AU/ML model inference output is the output of the machine learning model 105b. The Model inference unit 104 is also responsible for data preparation (e.g., data pre-processing and cleaning, formatting, and transformation) based on inference data delivered by the data collection unit 101, if required.

The output shown between unit 103 and unit 104 is the inference output of the AI/ML model produced by the model inference unit 104.

Actor 103 is a function that receives the output from the model inference unit 104 and triggers or performs corresponding actions. The actor 103 may trigger actions directed to other entities or to itself.

Feedback between unit 103 and unit 101 is information that may be needed to derive training or inference data or performance feedback.

With reference to FIG. 6, an example of a UE (e.g., UE 10) in the description may include one of the UE 10a. Examples of a gNB (e.g., gNB 20) in the description may include the base station 20a or 20b. Note that even though the gNB is described as an example of base station in the following, the disclosed method of may be implemented in any other types of base stations, such as an eNB or a base station for beyond 5G. Uplink (UL) transmission of a control signal or data may be a transmission operation from a UE to a base station. Downlink (DL) transmission of a control signal or data may be a transmission operation from a base station to a UE. The disclosed method is detailed in the following. The UE 10 and a base station, such as a gNB 20, execute the data transfer method.

FIG. 6 shows an embodiment of the disclosed method. At least one wireless communication device executes a data transfer method based on machine learning. In an embodiment, the at least one wireless communication device may comprise a user equipment (UE). In another embodiment, the at least one wireless communication device may comprise a base station. In still another embodiment, the at least one wireless communication device may comprise a combination of UEs and base stations.

A wireless communication device, such as the UE 10 or the gNB 20, transfers data between a user equipment (UE) and a base station by an enhanced radio bearer (RB) or a control information unit of the radio protocol layer, wherein the data transfer is between a function entity in the UE and a function entity in the base station (S10). The function entities may be located in one or more of Packet Data Convergence Protocol (PDCP), Radio Link Control (RLC), medium access control (MAC), and physical layers

As discussed above, the data delivery/transfer for data collection also includes two directions, i.e., a downlink direction from NW to UE or an uplink direction from UE to NW. In this description, although the case where data is delivered/transferred in the uplink direction from UE to NW (e.g., a gNB) is illustrated in the following, the disclosed method may be likewise applied to the downlink direction.

The data is collected by a data collection function. In an embodiment, the data may be carried by the control information unit which is uplink control information (UCI) in a new UCI format in the physical protocol layer. Configuration of the UCI format comprises one or more categories of information including:
time resource information for time domain resource allocation,
frequency resource information for frequency domain resource allocation,
power information for power control, and
UCI rate compensation for data rate compensation.

In some embodiments of the disclosure, the data is carried in two-stage control messages. The two-stage control information may be uplink control information (UCI), downlink control information (DCI), or sidelink control information (Sidelink Channel Information (SCI). An example of the two-stage UCI is two-part channel state information (CSI).

The two-stage control messages comprise a first stage control message and a second stage message. The first stage control message comprises one or more of:
an AI data collection indication used to distinguish whether a second stage control message of the two-stage control messages is used for AI data collection or not,
an AI data segmentation order used to index segments of the data; and
a number of slots used for the two-stage control information, which indicates how many slots are used for transmission of the data through the two-stage control information.

In some embodiments of the disclosure, the data is carried by the control information unit which is a data medium access control (MAC) control element (CE) in the MAC protocol layer. The data MAC CE is identified by a MAC subheader with a predefined logical channel identity (LCID) and/or an extended logical channel identity (LCID). One or more types of identity information are transmitted along with the data in the MAC CE, and the identity information comprises one or more of:
a UE identity;
a Cell ID
a scenario ID;
a zone ID;
a site ID;
a functionality ID; and
a model ID.

The Data MAC CE may be an AI data collection MAC CE for AI/ML data collection. The data MAC CE comprises:
an SN field that contains a sequence number of a segment of the data in the Data MAC CE;
an E field that indicates whether a segment in the MAC CE is the last segment or not;
a serving Cell ID that indicates an identity of a serving cell for which the MAC CE applies; and
a data field that contains the data or a segment of the data in the Data MAC CE.

In an embodiment the data is carried in the control information unit which is a radio link control (RLC) control protocol data unit (PDU) referred to as a data protocol data unit (PDU) in the RLC protocol layer. The data RLC control PDU may be an AI data collection PDU for AI/ML data collection. In an embodiment, the Data RLC control PDU consists of AI data payload and an RLC control PDU header. The RLC control PDU header consists of a D/C field and a CPT field. The D/C field indicates whether a RLC PDU is an RLC control PDU or not. The CPT field indicates a type of the RLC control PDU, wherein a predefined CPT value represents a PDU type of the Data RLC control PDU. The Data RLC control PDU comprises:
an SN field that contains a sequence number of a segment of the data in the Data RLC control PDU;
and
an E field that indicates whether a segment in the Data RLC control PDU is the last segment or not.

In an embodiment, the data is carried in the control information unit which is a PDCP control PDU referred to as Data PDCP control PDU in the PDCP protocol layer. The Data PDCP control PDU is an PDCP control PDU for AI/ML data collection. The Data PDCP control PDU consists of AI data payload and an PDCP control PDU header. The PDCP control PDU header consists of a D/C field and a PDU type field. The D/C field indicates whether a PDCP PDU is an PDCP control PDU or not. The PDU type field indicates a type of control information included in the PDCP control PDU, wherein a predefined PDU type value represents a PDU type of the Data PDCP control PDU. The Data PDCP Control PDU comprises:
an SN field that contains a sequence number of a segment of the data in the Data PDCP Control PDU; and
an E field that indicates whether a segment in the Data PDCP Control PDU is the last segment or not.

In an embodiment, the data is carried in the enhanced radio bearer initiated by an RRC message with a EstablishmentCause that indicates an establishment cause for the data collection function or for data transfer between the function entity in the UE and the function entity in the base station. The data collection function is AI/ML data collection function. The RRC message comprises a RRCReconfiguration message, RRCSetup message, or RRCResume message.

The enhanced radio bearer is configured with one or more of:
parameters related to quality of service (QoS);
physical layer configuration;
MAC layer configuration;
RLC layer configuration; and
PDCP layer configuration.

The gNB 20 may perform the configuration for the UE 10.

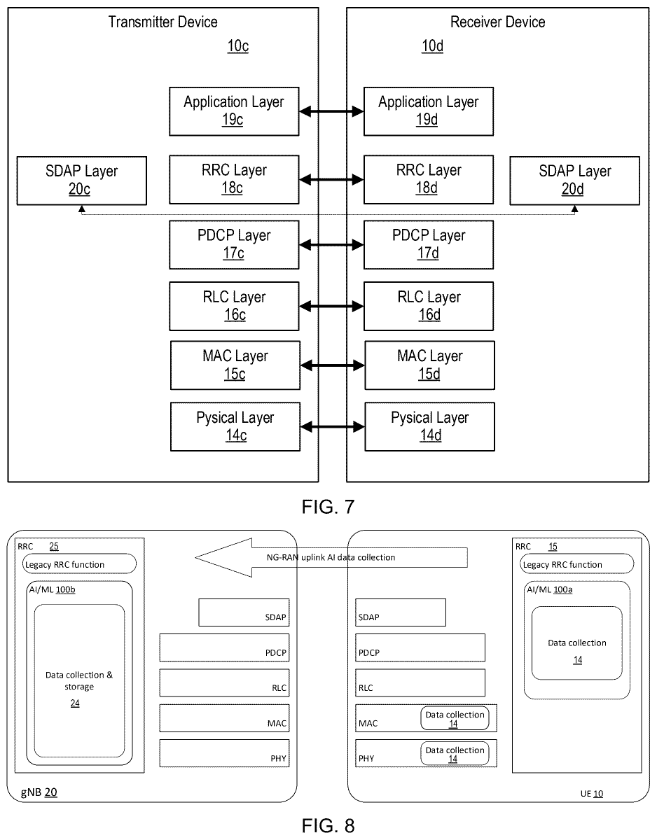

With reference to FIG. 7, an example of a transmitter device is shown as transmitter device 10c, and an example of a receiver device is shown as receiver device 10d. The transmitter device 10e comprises a physical layer (PHY layer or L1 layer) 14c, MAC layer 15c, RLC layer 16c, PDCP layer 17e, RRC layer 18e, and application layer 19c. The receiver device 10d comprises a physical layer (PHY layer or L1 layer) 14d, MAC layer 15d, RLC layer 16d, PDCP layer 17d, RRC layer 18d, and application layer 19d. For example, when the application layer 19e of the transmitter device 10c sends a PDU through lower layers (i.e., PDCP layer 17c, RLC layer 16c, MAC layer 15c, and physical layer 14e) to the application layer 19d of the receiver device 10d, the layers in transmitter device 10c serves as transmitting protocol layer entities at the transmitting side, and the layers in receiver device 10d serve as receiving protocol layer entities at the receiving side. Embodiments of the disclosed may be implemented in the PDCP layer or RLC layer. One or more steps (or blocks) in of embodiments of the disclosure may be implemented as computer programs, instructions, software module(s) stored in a memory of the transmitter device, or circuits or hardware module(s) in a processor of the transmitter device, or IC chip(s), circuits, or plug-in(s) of the transmitter device.

A device executing the data transfer method may be a transmitter device that transmits collected data of an XR service to a receiver device that receives the collected data. The collected data may comprise one or more data sets. For example, the device executing the data transfer method may comprise the gNB 20, an application server in a data network, or a UE. That is, the application server in data network may operate as a transmitter device that executes a data transfer method in some data delivery occasions, while one or more clients (e.g., one or more of the UE 10, UE 10a, and UE 10b) operates as the receiver device receiving the collected data sent from the transmitter device. Similarly, a client (e.g., one or more of the UE 10, UE 10a, and UE 10b) may operate as a transmitter device to execute a data transfer method in some data delivery occasions, while another client or the application server operates as the receiver device receiving the collected data sent from the transmitter device. Alternatively, the transmitter device may comprise an intermediate device between the UE 10 and the application server. The UE 10 may comprise an embodiment of the UE 10a or UE 10b. The gNB 20 may comprise an embodiment of the base station 20a. Note that although the gNB 20 and UPF/5GC 30b are described as an example in the description, the data transfer method may be executed by a base station, such as another gNB, an eNB, a base station integrating an eNB and a gNB, or a base station for beyond 5G technologies. The UPF/5GC 30b may comprise another network entity of 5GC.

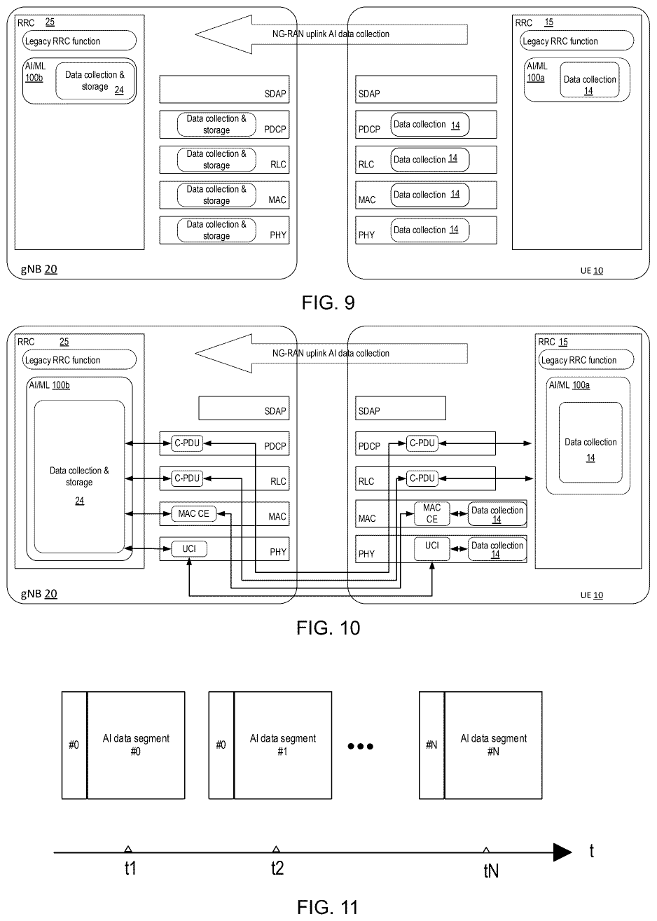

For the uplink data collection function, a gNB (e.g., a gNB 20 in FIG. 9) can have a Data collection and storage function entity 24. AI/ML units 100a and 100b are examples of the system 100. The collected AI data may be used as training data for the model training 102 and inference data for the model inference 104. A UE (e.g., a UE 10 in FIG. 9) can have a Data collection function entity 14. With reference to FIG. 8, basically, the Data collection and storage function 24 in gNB 20 can be a standalone module and commonly shared by all radio protocol layers. Alternatively, each radio protocol layer in gNB 20 has a separate Data collection and storage function 24. Additionally, some of the radio protocol layers may share a common Data collection and storage function 24, and some of radio protocol layers may have separate Data collection and storage function entities 24. Similarly, the Data collection function entity 14 in UE 10 can be a standalone module and commonly shared by all radio protocol layers, or each radio protocol layer in UE 10 has a separate Data collection function entity 14. Alternatively, some of the radio protocol layers may share a common Data collection function entity 14, and some of radio protocol layers may have separate Data collection function entity 14. Two examples are described in the following:

Option 1: As shown in FIG. 9, the Data collection and storage function entity 24 in gNB 20 is a common function for all the radio protocol layers, and the Data collection function entity 14 in UE 10 consist of three parts: a Data collection for PHY layer, a Data collection for MAC layer, and a Data collection for other layers which located in RRC layer 15.

Option 2: As shown in FIG. 7 FIG. 9, each the radio protocol layer has separate Data collection and storage function entity 24 in gNB 20, and each the radio protocol layer has separate Data collection function entity 14 in UE 10.

The overall solution is to utilize the control information of the radio protocol layers to support AI data collection for different radio protocol layers, such as control PDU (referred to as C-PDU) in RLC, and PDCP layer and MAC CE (Control Element) in MAC layer, and UCI (Uplink Control information) in PHY layer. Some new types of control information can be defined to carry AI data from UE 10 to gNB 20 as illustrated in FIG. 8 FIG. 10 which is based on the example in FIG. 6 FIG. 9.

Moreover, for the Data collection in RRC layer 15, a specially configured RB can be used to transfer from UE 10 to gNB 20. Such DRB or SRB can be referred to as enhance DRB or SRB.

Based on the above two solutions, compared to the legacy SRB or DRB, more than one new method is disclosed for transmitting or receiving data carried in an enhanced RB between UE 10 and gNB 20, the enhanced RB may be a enhance SRB or DRB.

Following embodiments are illustrated for AI data collection. However, those methods are not used for only AI data collection between UE 10 and gNB 20, but also the other data transfers that start from UE 10 and end at gNB 20 or vice versa. In the embodiment 1, 2, 3, 4, the RB is enhanced by enhancing the control information unit of the corresponding radio protocol layers of a RB. In the embodiment 5, a new type of RB is introduced based on legacy SRB or DRB.

### Embodiment 1: Data Collection by UCI

To support periodic, semi-static, or aperiodic AI data collection from UE 10, the L1 signaling of uplink control information (UCI) can be utilized. The format of UCI is defined in 3GPP TS 38.212, and the embodiment provides enhancements to the UCI for AI data collection and transfer. Various UCI formats have been defined in NR, ranging from physical uplink control channel (PUCCH) format 0 to format 4, which includes SR. CSI, and HARQ-ACK. With pre-configuration of the UCI transmission resource (such as time, frequency, RBs, sequence, etc.), the gNB 20 can decode the UCI information without real-time associated DCI information.

However, regarding the design of UCI, format 0 and format 1 can only support 1 or 2 bit information. Format 2 can support a maximum data load of 16 RBs with 2 OFDM symbols. Format 3 can support up to 4608 bits of information transmission. Format 4 has less capability compared to format 3 due to user multiplexing supported in the scheme. Therefore, the current UCI design has limited capacity for data transmission and is unable to support the transmission of larger volume data for AI data collection.

To address the current bottleneck in UCI, two methods have been proposed, including a new UCI format dedicated to AI data collection and an enhancement to existing UCI to support the transmission of massive amounts of AI data. Details of these methods are described on the following.

### (1). A New UCI Format Dedicated to AI Data Collection:

FIG. 11 shows the data structure of the new UCI format, which includes an indication of an order of AI data segmentation and AI data transmitted in the new UCI in the order. Those two parts can be encoded together or independently encoded. More robust transmission for the indication of the order can be achieved by independent coding of the two parts. An axis t represent the time domain, where AI data segments #0, #1, . . . and #N are transmitted at time t1, t2, . . . and tN. Each of K, N, and M is an positive integer.

To support the new UCI format, dedicated signaling is used for configuration of the new UCI format. The configuration of the new UCI format comprises one or more categories of information including time and frequency resource information for time and frequency domain resource allocation, power information for power control, and UCI Rate Compensation for data rate compensation. Radio resources used for the UCI in the new UCI format are referred to as used resources. For example, RBs used for the UCI in the new UCI format are referred to as used RBs, and slots used for the UCI in the new UCI format are referred to as used slots. The gNB 20 configures at least one of the following information to UE 10 to make the UCI format available at UE 10 side.
Frequency resource information for frequency domain resource allocation: The frequency resource information includes a start position of RBs and a number of RBs used for the UCI in the new UCI format.
Timing resource information for time domain resource allocation: The time resource information includes at least the one of the following, a start position of an OFDM symbol among OFDM symbols in each slot used for the UCI in the new UCI format, a number of slots and periodicity of the slots used for the UCI in the new UCI format. Usage of the information is explained later in the following.
Power information: The power information includes a power value that is to be used for the UCI in the new UCI format.
UCI Rate Compensation: In order to compensate for any loss in data rate when the UCI in new UCI format is transmitted, the UCI Rate Compensation is used to increase a modulation and coding scheme (MCS) of data.

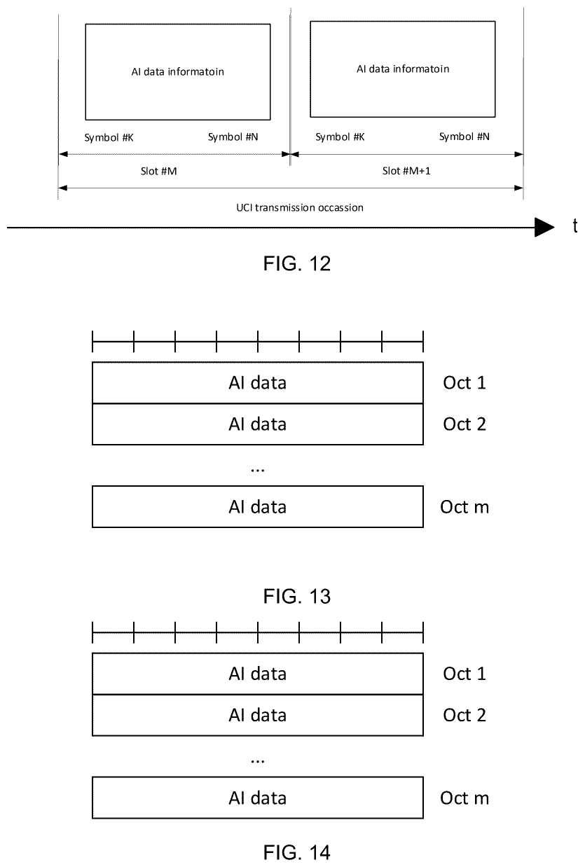

As shown in FIG. 12, if the new UCI format includes more than one slot or supporting cross-slot transmission, the transmission scheme, among which one or more subsequent slots share the same configuration as the first slot, including the frequency and time resource allocation, power, and rate compensation. Specifically, when the more than one slot comprises a first slot and one or more subsequent slots that follow the first slot, or when the cross-slot transmission involves a first slot and one or more subsequent slots that follow the first slot, the one or more subsequent slots share the same configuration as the first slot.

### (2). Enhancement to Current UCI Format to Support AI Data Collection:

To increase the reliability and accuracy of the CSI information, 3GPP introduced a two-part CSI transmission scheme in UCI. The first part of CSI provides overall information about the channel quality across the entire bandwidth and indicates what would be contained at the second part of CSI. The second part of CSI provides detailed information about the channel quality of specific subcarriers. By this way, the CSI loading can be dynamically changed according to CSI measurement requirements.

Similarly, the same scheme can be used for AI data collection and transmission from UE 10. Some enhancements should be provided to the two-part CSI transmission to realized two part UCI transmission for AI data collection and transmission, as shown in the following drawings. According to the enhancement, the first part CSI comprises one or more types of the following information:
An AI data collection indication: The indication is used to distinguish whether the second part CSI of the two-part CSI is used for legacy feedback (e.g., PMI, CQI, etc.) or for AI data collection. The AI data collection indication can be represented by a Boolean value, a string, or a bitmap. For example, when the AI data collection indication is represented by a Boolean value, the indication of a value 0 means legacy feedback information is carried by the second part CSI, and the indication of a value 1 means AI data is carried by the second part CSI.
An AI data segmentation order: The AI data segmentation order is used to index the transmitted segments of the AI data, and to inform gNB 20 of how to combine those segments in the new UCI to reproduce the AI data. The AI data segmentation order can be represented by integer values or a bitmap. For example, when the AI data segmentation order is represented by a bitmap, and a maximum number of segments into which the AI data can be segmented is up to three segments, “000” means no segmentation; “001” means the first segment; “010” means the second segment; and “100” means the third segment. Additionally, in order to inform the gNB 20 of completion of the segmentation, the UE 10 can also use the AI data segmentation order with a value of “111” to indicate the last segment of the AI data.
The number of slots used for the UCI: The number of slots used for the UCI indicates how many slots are used for the AI data transmission through the two-part CSI, as shown in FIG. 10. One or more subsequent slots share the same configuration as the first slot, including the frequency and time resource allocation, power, and rate compensation.

The second part CSI will carry information according to the indication in the first part CSI. For example,
When the AI data collection indication is 0, the second part CSI will carry the legacy CSI feedback. When the AI data collection indication is 1, the second part CSI will carry AI data.
When the AI data collection is valid, the AI data segmentation order is used to indicate how to split the AI data into segments by UE 10, and how to combine those segments of AI data in UCI.

### Embodiment 2: Data Collection by MAC CE

For the Data collection function entity 14 in MAC entities (the entity for MAC layer) or RRC entity 15 (the entity for RRC layer), the collected AI data can be transferred from UE 10 to gNB 20 by a MAC CE which is called AI data collection MAC CE. The format of MAC CE is defined in 3GPP TS 38.321, and the embodiment provides enhancements to the MAC CE for AI data collection and transfer.
The AI data collection MAC CE is identified by a MAC subheader with a predefined LCID and/or eLCID. The predefined LCID and/or eLCID may represent the AI data collection MAC CE.
As one embodiment, the collected AI data can be transferred from UE 10 to gNB 20 transparently by the MAC layer, the AI data collection MAC CE can be defined as that in FIG. 13.
As another embodiment, the MAC layer in UE 10 non-transparently transfers one or more types of identity information from UE 10 to gNB 20, along with the collected AI data in the MAC CE. The identity information comprises one or more of:
   A UE identity, for example, the C-RNTI of the UE 10;
   A Cell ID, for example, the Serving Cell ID of the UE 10;
   A scenario ID,
   A zone ID;
   A site ID;
   A functionality ID; and
   A model ID, such as AI model ID.

For example, FIG. 14 shows the AI data collection MAC CE with a serving Cell ID.

As an embodiment in FIG. 10, an example of the AI data collection procedure is provided in the following:
1. The Data collection function entity 14 of the MAC entity (the entity for MAC layer) in UE 10 collects AI data.
2. The MAC entity in UE 10 encapsulates the collected AI data into AI data collection MAC CE and then transfers the MAC CE to the PHY layer in UE 10. The PHY layer in UE 10 transfers the MAC CE to the PHY layer in gNB 20.
3. The MAC entity in gNB 20 receives the AI data collection MAC CE from the PHY layer, and then decapsulates the MAC CE to get the collected AI data.
4. The MAC entity in gNB 20 transfer the collected AI data to the Data collection and storage function entity 24. The collected AI data may be used as training data for the model training 102 and inference data for the model inference 104.

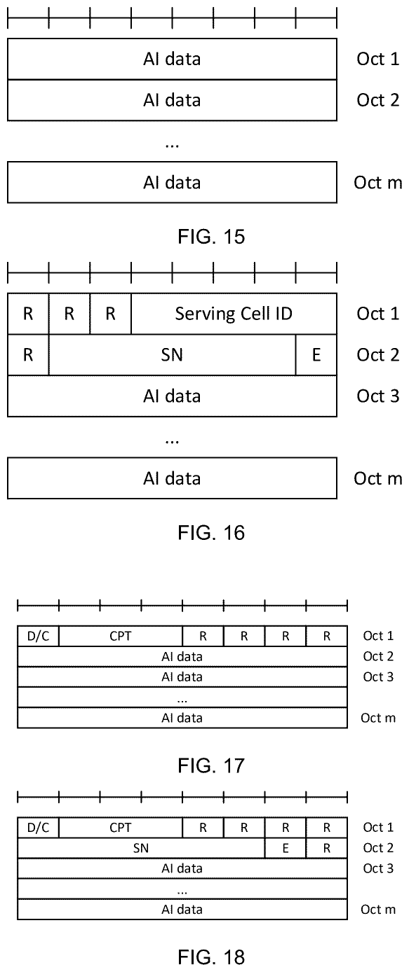

To enhance the transfer capability for AI data in MAC layer, segmentation and concatenation can be supported when encapsulating the collected AI data into AI data collection MAC CE. The MAC CE in FIG. 13 can be enhanced to that in FIG. 15. The MAC CE in FIG. 14 can be enhanced to that in FIG. 16. In FIGS. 14, 15, and 16, the fields are explained in the following:
R: This bit is reserved and not used.
SN: The SN field contains a sequence number of a segment of AI data in the AI data collection MAC CE, the length of the SN field can be predefined as an integer.
E: This bit indicates whether the segment in this MAC CE is the last segment or not. If the E bit is set to 1, the segment in this MAC CE is the last segment for the collected AI data. If the E bit is set to 0, the segment in this MAC CE is not the last segment for the collected AI data.
Serving Cell ID: This field indicates the identity of the Serving Cell for which the MAC CE applies. The length of the field is 5 bits.
AI data field: This fields contain the collected AI data or a segment of the collected AI data in the AI data collection MAC CE. The size of this field is variable.

As an embodiment in FIG. 10, the AI data collection procedure can be described as follows when segmentation and concatenation are supported in the MAC layer:
1. The Data collection function entity 14 of the MAC entity (the entity for MAC layer) in UE 10 collects the AI data.
2. The MAC entity in UE 10 segments and encapsulates the collected AI data into one or more AI data collection MAC CEs. The one or more AI data collection MAC CEs comprises segments of the AI data with the SNs of the segments. The one or more AI data collection MAC CEs comprises an indication indicating whether a segment is the last segment. The MAC entity in UE 10 then transfers the one or more AI data collection MAC CEs to the PHY layer in UE 10. The PHY layer in UE 10 transfers the one or more AI data collection MAC CEs to the PHY layer in gNB 20.
3. The MAC entity in gNB 20 receives the one or more AI data collection MAC CEs from the PHY layer, decapsulates the one or more AI data collection MAC CEs to get the segments of the collected AI data, concatenates the segments according the SNs until the last segments is received, and reproduces the AI data.
4. The MAC entity in gNB 20 transfers the collected AI data to the Data collection and storage function entity 24. The collected AI data may be used as training data for the model training 102 and inference data for the model inference 104.

### 5.1 Embodiment 3: Data Collection by RLC PDU

For the Data collection in RLC entities (the entity for RLC layer) or RRC entity (the entity for RRC layer), the collected AI data can be transferred from UE 10 to gNB 20 by a RLC control PDU which is called AI data collection PDU.

The AI data collection PDU consists of AI data payload and an RLC control PDU header.

As shown in FIG. 17, the RLC control PDU header consists of a D/C field and a CPT field.
D/C: The D/C field indicates whether the RLC PDU is an RLC data PDU or RLC control PDU. For example, if the D/C bit is set to 1, the RLC PDU is a RLC control PDU; or if the D/C bit is set to 0, the RLC PDU is a RLC data PDU.
CPT: The CPT field indicates the type of the RLC control PDU. Details of the CPT field are defined in 3GPP TS 38.322.

The AI data collection PDU is identified by the RLC control PDU header with a predefined CPT value. The predefined CPT value represents the PDU type of the AI data collection PDU.

To enhance the transfer capability for AI data in RLC layer, segmentation and concatenation can be supported when encapsulating the collected AI data into AI data collection PDU. The control PDU in FIG. 14 FIG. 17 can be enhanced to that in FIG. 15 FIG. 18.

The fields are explained as follows:
R: This bit is reserved and not used.
SN: The SN field contains a sequence number of a segment of AI data in the AI data collection PDU, the length of the SN field can be predefined as an integer.
E: This bit indicates whether the segment in this RLC PDU is the last segment or not. If the E bit is set to 1, the segment in this RLC PDU is the last segment for the collected AI data. If the E bit is set to 0, the segment in this RLC PDU is not the last segment for the collected AI data.

### Embodiment 4: Data Collection by PDCP PDU

For the Data collection in PDCP entities (the entity for PDCP layer) or RRC entity (the entity for RRC layer), the collected AI data can be transferred from UE 10 to gNB 20 by a PDCP control PDU which is called PDCP Control PDU for AI data collection.

The PDCP Control PDU for AI data collection can consist of an AI data payload and an PDCP control PDU header.

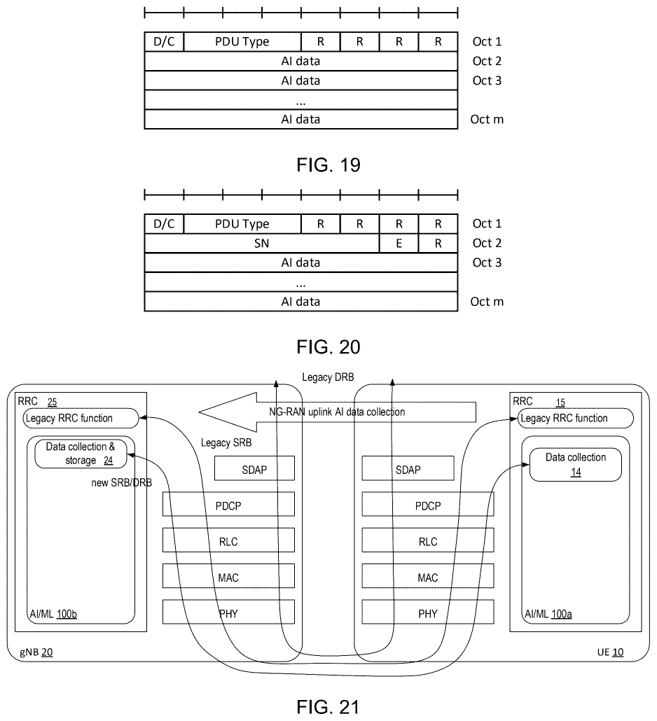

With reference to FIG. 19, the PDCP control PDU header consists of a D/C and a PDU Type field.
D/C: The D/C field indicates whether the PDCP PDU is an PDCP data PDU or PDCP control PDU. For example, if the D/C bit is set to 1, the PDCP PDU is a PDCP control PDU; or if the D/C bit is set to 0, the PDCP PDU is a PDCP data PDU.
PDU Type: This field indicates the type of control information included in the PDCP control PDU, which is defined in 3GPP TS 38.323.

The PDCP Control PDU for AI data collection is identified by the PDCP control PDU header with a predefined PDU Type value. The predefined PDU Type value represents the PDU type of PDCP Control PDU for AI data collection.

To enhance the transfer capability for AI data in PDCP layer, segmentation and concatenation can be supported when encapsulating the collected AI data into PDCP Control PDU for AI data collection. The control PDU in FIG. 19 can be enhanced to that in FIG. 20.

The fields are explained as follows:
R: This bit is reserved and not used.
SN: The SN field contains a sequence number of a segment of AI data in the PDCP Control PDU for AI data collection, the length of the SN field can be predefined as an integer.
E: This bit indicates whether the segment in this PDCP Control PDU for AI data collection is the last segment or not. If the E bit is set to 1, the segment in this PDCP PDU is the last segment for the collected AI data. If the B bit is set to 0, the segment in this PDCP PDU is not the last segment for the collected AI data.

### Embodiment 5: Dat a Collection by Radio Bearer (RB)

The format of RRC is defined in 3GPP TS 38.331, and the embodiment provides enhancements to the RRC for AI data collection and transfer.

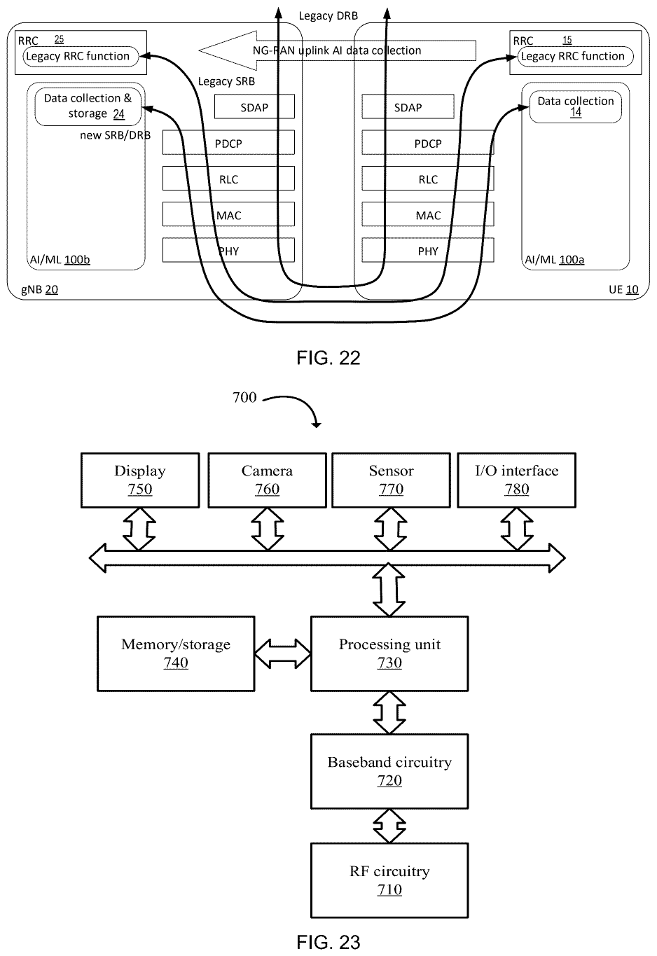

With reference to FIG. 21, the Data collection function entity 14 for collecting the data is located in a radio resource control (RRC) layer 1S. Alternatively, with reference to FIG. 22, the Data collection function entity 14 for collecting the data is located in a data plane out of the RRC layer 15.

As illustrated in FIG. 21 and FIG. 22, the Data collection and storage function entity 24 in gNB 20 can be located in RRC layer 25, and the Data collection function entity 14 in UE 10 can be located in RRC layer 15 or a new functionality in a new plane, such as data plane. For both of these two cases, collected AI data can be transferred through an enhanced RB in the uplink direction form UE 10 to gNB 20.

As illustrated in FIG. 21 and FIG. 22, compared with the legacy DRB which is used to carry the service data from a QoS flow and the legacy SRB which is used to carry the RRC messages, an enhanced RB is a new type of RB configured for the data transfers between UE 10 and gNB 20. For example, AI data transfer in the uplink direction for the AI data collection starts from UE 10 and ends at gNB 20, while AI data transfer in the downlink direction for AI data collection starts from gNB 20 and ends at UE 10. The new type of RB is called R-DRB (RAN DRB) in this description. As an embodiment, the R-DRB can be a special SRB or a DRB.

The structure or framework of the R-DRB for AI data transfer between UE 10 and gNB 20 is the same as or similar to that of the legacy SRB or DRB. The R-DRB is also defined and consists of a series of configured resources for one or more radio protocol layers, such as PHY, MAC, RLC and/or PDCP protocol layer.

In establishing a R-DRB for AI data transfer between UE 10 and gNB 20, according to the current RRC protocol, the UE 10 may use a new EstablishmentCause in a RRCSetupRequest message to indicate to gNB 20 that the EstablishmentCause is establishing a R-DRB and requests the gNB 20 to establish a R-DRB for the AI data transfer between data collection entity 14 of UE 10 and data collection and storage entity 24 in gNB 20. For example, as shown in table 2, the added EstablishmentCause is “RAN-Data”.

TABLE 2

| EstablishmentCause ::=ENUMERATED { | |
|---|---|
| | emergency, highPriorityAccess, mt-Access, mo-Signalling, |
| | mo-Data, mo-VoiceCall, mo-VideoCall, mo-SMS, mps- |
| PriorityAccess, | mcs-PriorityAccess, RAN-Data, spare5, spare4, spare3, |
| | spare2, spare1} |

According to the EstablishmentCause which is “RAN-Data”, gNB 20 can establish a R-DRB for AI data transfer between UE 10 and gNB 20 by sending a RRCReconfiguration message, RRCSetup message, or RRCResume message to UE 10.

For the R-DRB for AI data transfer between UE 10 and gNB 20, gNB 20 should determine parameters related to the QoS and the configurations for PHY, MAC, RLC and PDCP based on predefined information.

Once the R-DRB for AI data transfer between the UE 10 and gNB 20 has been established, packets containing the collected AI data can be transferred between the Data collection function entity (DCF) 14 in the UE 10 and the Data collection and storage function entity (DCSF) 24 in the gNB 20, in both directions.

### Activate and Deactivate the Data Collection

After the Data collection function entity 14 is configured, the data transfer for collected AI data can be activated or deactivated by a control message, such as DCI, a MAC CE, or a RRC message. The activated or deactivated message can be transmitted from gNB 20 to UE 10 or from UE 10 to gNB 20.

FIG. 23 is a block diagram of an example system 700 for wireless communication according to an embodiment of the present disclosure. Embodiments described herein may be implemented into the system using any suitably configured hardware and/or software. FIG. 23 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

In various embodiments, the system 700 may be a mobile computing device such as, but not limited to, a laptop computing device, a tablet computing device, a netbook, an ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that can be adopted in 3GPP specification to create an end product.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random-access memory (RAM), a floppy disk, or other kinds of media capable of storing program codes.

Embodiments of the disclosure provides solutions for data collection and transfer using control messages or an enhanced radio bearer in a radio access network. The control message in Uu interface is enhanced to transmits data or data segments. Indexing information for data segmentation and concatenation for reproducing the collected data is also include in the control message. The control message may be transmitted in two-stage control messages, including a first-stage control message and a second-stage control message. The first-stage control message comprises overall information of the collected data, an introduction and an index to the second-stage control message. The second-stage control message comprises more details of the collected data. A Data collection function entity may be located in one or more of radio resource control (RRC) layer, Packet Data Convergence Protocol (PDCP) layer, medium access control (MAC) layer, and physical (PHY) layer. Alternatively, the Data collection function entity may be a standalone module commonly shared and interacting with the layers. The data collection function may be activated or deactivated by a control signal, such as downlink control information (DCI), a MAC CE, or an RRC message.

The enhanced radio bearer may be an SRB or a DRB. QoS parameters and configuration for different layers are configured for the enhanced radio bearer. The enhanced radio bearer may be established based on a EstablishmentCause that indicates an establishment cause for transmission of the collected data.

The collected AI data may be used as training data for the model training and inference data for the model inference.

The disclosure provides a mechanism for data collection and transfer using control plane signals, thus facilitating machine learning or AI to be applied to assist control plane functions, such as decision for beam operations, cell selection, operating state transition, and others.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A data transfer method for data collection and data management, executable in a wireless communication device, comprising:
transferring or receiving data between a user equipment (UE) and a base station by an enhanced radio bearer (RB) or a control information unit of the radio protocol layer, wherein the data transfer is between a function entity in the UE and a function entity in the base station.

2. The method of claim 1, wherein the function entity is located in one or more of Packet Data Convergence Protocol (PDCP), Radio Link Control (RLC), medium access control (MAC), and physical layers, radio resource control (RRC) layer or in a data plane out of the RRC layer.

3. The method of claim 1, wherein the data is transferred by the control information unit which is a uplink control information (UCI) in a new UCI format in the physical protocol layer.

4. The method of claim 3, wherein configuration of the new UCI format comprises one or more categories of information including:
time resource information for time domain resource allocation,
frequency resource information for frequency domain resource allocation,
power information for power control, and
UCI rate compensation for data rate compensation.

5-7. (canceled)

8. The method of claim 4, wherein the UCI rate compensation which used to increase a modulation and coding scheme (MCS) of data to compensate for a loss in data rate when the UCI in new UCI format is transmitted.

9. The method of claim 4, wherein the new UCI format includes more than one slot or supporting cross-slot transmission;
when the more than one slot comprises a first slot and one or more subsequent slots that follow the first slot, or when the cross-slot transmission involves a first slot and one or more subsequent slots that follow the first slot, the one or more subsequent slots share the same configuration as the first slot.

10. The method of claim 1, wherein the data is carried in two-stage control messages.

11. The method of claim 10, wherein the two-stage control messages is two-part channel state information (CSI), of which a first part CSI comprises one or more of:
an AI data collection indication used to distinguish whether second part CSI of the two-part CSI is used for AI data collection or not;
an AI data segmentation order used to index segments of the data; and
a number of slots used for the UCI, which indicates how many slots are used for transmission of the data through the two-part CSI.

12. The method of claim 1, wherein the data is transferred by the control information unit which is a medium access control (MAC) control element (CE) referred to as a Data MAC CE in the MAC protocol layer, wherein the Data MAC CE is identified by a MAC subheader with a predefined logical channel identity (LCID) and/or an extended logical channel identity (LCID).

13. (canceled)

14. The method of claim 12, wherein one or more types of identity information are transmitted along with the data in the MAC CE, and the identity information comprises one or more of:
a UE identity;
a Cell ID
a scenario ID;
a zone ID;
a site ID;
a functionality ID; and
a model ID.

15. The method of claim 12, wherein the Data MAC CE comprises:
an SN field that contains a sequence number of a segment of the data in the Data MAC CE;
an E field that indicates whether a segment in the MAC CE is the last segment or not;
a serving Cell ID that indicates an identity of a serving cell for which the MAC CE applies; and
a data field that contains the data or a segment of the data in the Data MAC CE.

16. The method of claim 1, wherein the data is transferred by the control information unit which is a radio link control (RLC) control protocol data unit (PDU) referred to as a Data RLC control PDU in the RLC protocol layer.

17. The method of claim 16, wherein the Data RLC control PDU consists of data payload and an RLC control PDU header;
the RLC control PDU header consists of a D/C field and a CPT field;
the D/C field indicates whether a RLC PDU is an RLC control PDU or not; and
the CPT field indicates a type of the RLC control PDU, wherein a predefined CPT value represents a PDU type of the Data RLC control PDU.

18. (canceled)

19. The method of claim 1, wherein the data is transferred by the control information unit which is a PDCP control PDU referred to as Data PDCP Control PDU in the PDCP protocol layer.

20. The method of claim 19, wherein the Data PDCP Control PDU consists of AI data payload and an PDCP control PDU header;
the PDCP control PDU header consists of a D/C field and a PDU type field;
the D/C field indicates whether a PDCP PDU is an PDCP control PDU or not; and
the PDU type field indicates a type of control information included in the PDCP control PDU, wherein a predefined PDU type value represents a PDU type of the Data PDCP Control PDU.

21-22. (canceled)

23. The method of claim 1, wherein the enhanced radio bearer is established based on an RRC message with a EstablishmentCause that indicates an establishment cause for the data transfer between the function entity in the UE and the function entity in the base station.

24. (canceled)

25. The method of claim 1, wherein the enhanced radio bearer is configured with one or more of:
parameters related to quality of service (QoS);
physical layer configuration;
MAC layer configuration;
RLC layer configuration; and
PDCP layer configuration.

26. The method of claim 1, wherein the function entity in the UE is a data collection in the UE and the function entity in the base station is a data collection and storage entity in a gNB for a data collection function; or
the function entity in the UE is a data collection and storage entity in the UE and the function entity in the base station is a data collection in a gNB for a data collection function.

27. (canceled)

28. The method of claim 1, wherein the data transfer is activated or deactivated by a control message including downlink control information (DCI), a MAC CE, or an RRC message.

29. A wireless communication device comprising:
a processor, configured to call and run a computer program stored in a memory, to cause a device in which the processor is installed to execute
a data transfer method for data collection and data management, wherein the method is executable in a wireless communication device and comprises: transferring or receiving data between a user equipment (UE) and a base station by an enhanced radio bearer (RB) or a control information unit of the radio protocol layer, wherein the data transfer is between a function entity in the UE and a function entity in the base station.

30-33. (canceled)
